(19) United States
(12) Patent Application Publication
(10) Pub. No.: US 2026/0022680 A1
(43) Pub. Date: Jan. 22, 2026

(54) Supersonic Oblique Rotating Detonation Engine and Method of Creating a Supersonic Oblique Rotating Detonation Wave

(71) Applicant: University of Central Florida Research Foundation, Inc., Orlando, FL (US)

(72) Inventors: Kareem Ahmed, Orlando, FL (US); Adam Kotler, Orlando, FL (US); Mason Thornton, Orlando, FL (US)

(21) Appl. No.: 18/662,543

(22) Filed: May 13, 2024

Related U.S. Application Data
(60) Provisional application No. 63/526,107, filed on Jul. 11, 2023.

(51) Int. Cl. F02M 25/00; F02K 9/00; F02M 61/18

(52) U.S. Cl. CPC F02M 25/00; F02K 9/00; F02M 61/1806

(57) ABSTRACT

The present disclosure is directed to a supersonic oblique rotating detonation wave engine (SORDE) and systems and methods for generating a supersonic oblique rotating detonation wave. The SORDE is configured to produce and sustain a supersonic oblique rotating detonation wave through the injection of fuel at supersonic speeds into an inlet air flow between Mach 1 and Mach 7. The SORDE and method include injecting fuel into the inlet air in an amount to generate an equivalence ratio of 0.2 to 2.5. Some embodiments include a plurality of fuel injector ports each having a diameter of about 0.010 inches to about 0.040 inches; an annular wedge disposed in or upstream of the detonation chamber with an angle of about 5 degrees to about 40 degrees relative to a longitudinal axis of the engine; and/or a cylindrical center body disposed in or upstream of the detonation chamber.

### CROSS-REFERENCE TO RELATED APPLICATIONS

This nonprovisional application claims priority to provisional application No. 63/526,107, entitled “Supersonic Oblique Rotating Detonation Engine,” filed Jul. 11, 2023 by the same inventors.

### FEDERALLY SPONSORED RESEARCH OR DEVELOPMENT

This invention was made with Government support under Grant No. FA9550-19-1-0322 awarded by the Air Force Office of Scientific Research and Grant No. W911NF-20-1-0280 awarded by the United States Army. The government has certain rights in the invention.

### BACKGROUND OF THE INVENTION

### 1. Field of the Invention

This invention relates, generally, to rotating detonation engines. More specifically, it relates to a supersonic oblique rotating detonation wave engine (SORDE).

### 2. Brief Description of the Prior Art

There is a critical focus on achieving hypersonic capabilities.¹⁻⁴ Detonations as a high energetic mode (exergy) of hypersonic propulsion is one option. Detonation, a shock coupled reaction, is a key enabling technology for maintaining technological superiority of Department of Defense (DoD) high-speed propulsion and power systems.⁵ Detonation is an innovative scheme for hypersonics that considerably increases thermodynamic cycle efficiencies (˜10-20%). ^{4 ,6-8} Therefore, advancement in detonation research will augment the technological advantage of future DoD hypersonic propulsion and power generation systems.

Recent discovery of stabilized oblique detonations for hypersonic propulsion up to Mach 17 flight was published in the Proceedings of the National Academy of Sciences, PNAS⁴, and featured by numerous news media (e.g., News 6,⁹ Live Science,¹⁰ Academic Times, ¹¹ Physics World,¹² New Atlas¹³). Images from that study are reproduced in FIG. 1 of this disclosure. This disclosure, however, is directed to the first ever supersonic oblique rotating detonation for supersonic to hypersonic propulsion. In view of the art considered as a whole at the time the present invention was made, it was not obvious to those of ordinary skill in the field of this invention how to produce a supersonic oblique rotating detonation engine (SORDE) for supersonic to hypersonic propulsion.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for a system and method for producing and maintaining a SORDE is now met by a new, useful, and nonobvious invention.

The novel structure of the SORDE includes a detonation chamber in fluidic communication with a source of an oxidizer and a source of a fuel. The oxidizer is provider by an oxidizer inlet (e.g., an oxidizer nozzle or inlet port) configured to direct the oxidizer to the detonation chamber. The SORDE further includes a fuel injector configured to deliver fuel to the detonation chamber. The fuel injector and oxidizer inlet are configured to deliver the fuel and the oxidizer to the detonation chamber in an equivalence ratio of about 0.1 to about 3.0 or about 0.2 to about 2.5 to create a detonation wave. In addition, the oxidizer inlet is configured to direct the oxidizer to the detonation chamber at a speed that is less than, but greater than or equal to 0.2 times a wave speed of the created detonation wave. In some embodiments, the oxidizer speed is between Mach 1.2 and Mach 6.

In some embodiments, the fuel injector includes a plurality of fuel injector nozzles each with a diameter of about 0.010 inches to about 0.040 inches. In some embodiments, the fuel injector includes a plurality of fuel injector nozzles having a circumferential pitch on a time scale of about 0.5 to about 5 microseconds. In some embodiments, the fuel injector includes a plurality of fuel injector nozzles having a circumferential pitch between about 0.001 inches to about 0.47 inches.

Some embodiments of the SORDE further include an annular wedge disposed in or upstream of the detonation chamber. The annular wedge has an angle of about 5 degrees to about 40 degrees relative to a longitudinal axis of the detonation chamber. Some embodiments of the SORDE include a cylindrical center body disposed in or upstream of the detonation chamber, thereby creating an annular detonation channel.

Operation of the engine produces a supersonic oblique rotating detonation wave with an oblique angle between about 11.5 and about 90 degrees relative to a longitudinal axis of the detonation chamber. In addition, operation of the engine produces a supersonic oblique rotating detonation wave with a wave speed between about Mach 5 and about Mach 6.

The method of the present invention includes producing a supersonic oblique rotating detonation wave in an engine. The method includes injecting an oxidizer and a fuel into the detonation chamber and igniting the fuel to create a detonation wave in the detonation chamber. The method further includes injecting the fuel and oxidizer into a detonation chamber at a oxidizer/fuel equivalence ratio of about 0.1 to about 3.0 or 0.2 to 2.5 and directing the oxidizer into the detonation wave at a speed ratio between 0.2 and 1. The speed ratio is a ratio of a speed of the oxidizer relative to a wave speed of the detonation wave. The oxidizer/fuel equivalence ratio and the speed ratio are then maintained to cause the detonation wave to rotate about a longitudinal axis of the detonation chamber.

In some embodiments, the method further includes adjusting the oxidizer/fuel equivalence ratio until the wave speed is between about Mach 5 and about Mach 6 and/or adjusting the speed ratio until the detonation wave creates an oblique angle relative to the longitudinal axis of the detonation chamber and rotates about the longitudinal axis of the detonation chamber.

The method may employ the structural features described above in connection with the brief description of the novel structure or any structures described herein. For example, the method can include employing a fuel injector disposed in or upstream of the detonation chamber with a plurality of fuel injector nozzles each having a diameter of about 0.010 inches to about 0.040 inches; an annular wedge disposed in or upstream of the detonation chamber, where the annular wedge has an angle of about 5 degrees to about 40 degrees relative to the longitudinal axis of the detonation chamber; and a cylindrical center body disposed in or upstream of the detonation chamber, thereby creating an annular detonation channel.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a figure of a prior art system and findings for the first oblique detonation wave.⁴

FIG. 2 is a schematic of detonation regimes as F (Mᵢₙₗₑₜ).

FIG. 3A is a cross-sectional view of an embodiment of a SORDE.

FIG. 3B is a side view of an exemplary propellant injector and detonation chamber.

FIG. 4A is a perspective view of an exemplary propellant injector.

FIG. 4B is a side view of an exemplary propellant injector.

FIG. 4C is a cross-sectional view of an exemplary propellant injector.

FIG. 4D is a close-up cross-sectional view of Detail B from FIG. 4C.

FIG. 5 is a vector representation of the inlet speed, consumption speed, and rotational speed for a supersonic oblique rotating detonation wave (ORDW).

FIG. 6 is a representation of the relative vectors in FIG. 5 in conjunction with rotational arrows shown in an exemplary detonation chamber and from an end view through backend imaging.

FIG. 7A is a flowchart of an embodiment of the method of the present invention.

FIG. 7B is a flowchart of an embodiment of the method of the present invention.

FIG. 7C is a flowchart of an embodiment of the method of the present invention.

FIG. 8 is an embodiment of a detonation chamber configured to receive inlet air at Mach 5 and inject fuel through an annular injector.

FIG. 9 is an embodiment of a detonation chamber with an annular wedge configured to receive inlet air at Mach 5 and inject fuel through an annular injector.

FIG. 10 is an embodiment of a detonation chamber with a center structure configured to receive inlet air at Mach 5 and inject fuel through an annular injector.

FIG. 11 is picture of a detonation wave using backend imaging showing rotating detonation waves traveling at 400-600 m/s when the freestream velocity is at 1,500 m/s and the CJ detonation velocity is at 1,650 m/s.

FIG. 12 is a graph of the test section pressure tap captured during experimentation.

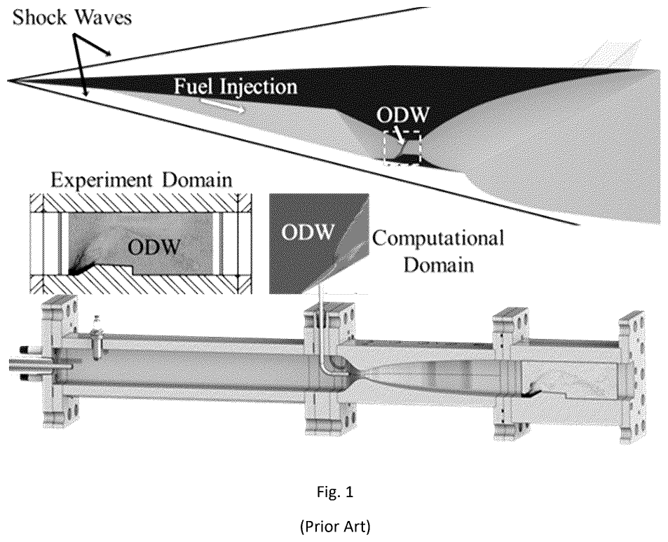

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The phrases “in some embodiments,” “according to some embodiments,” “in the embodiments shown,” “in other embodiments,” and the like generally mean the particular feature, structure, or characteristic following the phrase is included in at least one implementation. In addition, such phrases do not necessarily refer to the same embodiments or different embodiments.

All numerical designations, such as measurements, efficacies, physical characteristics, forces, and other designations, including ranges, are approximations which are varied up or down by increments of 1.0 or 0.1, as appropriate. It is to be understood, even if it is not always explicitly stated that all numerical designations are preceded by the term “about.” As used herein, “about” or “approximately” refers to being within an acceptable error range for the particular value as determined by one of ordinary skill in the art, which will depend in part on how the value is measured or determined. As used herein, the term “about” refers to ±10% of the numerical; it should be understood that a numerical including an associated range with a lower boundary of greater than zero must be a non-zero numerical, and the term “about” should be understood to include only non-zero values in such scenarios.

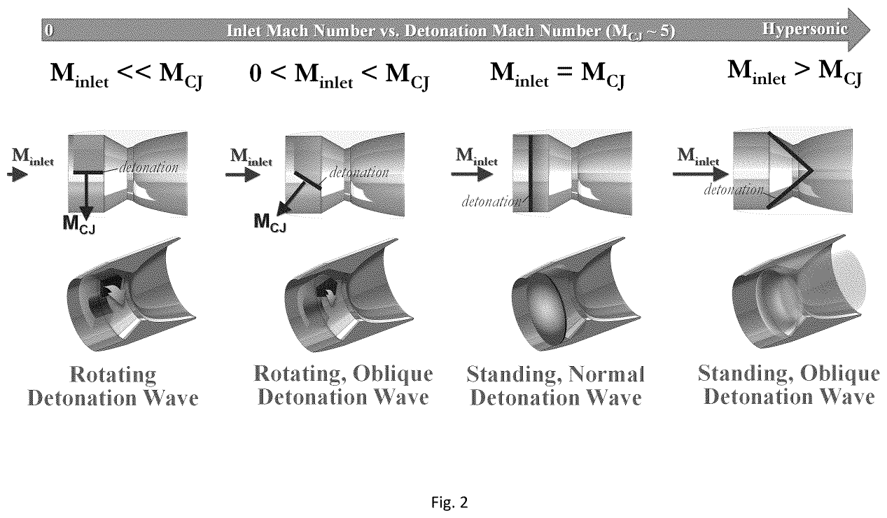

Currently, there are four theorized detonation modes as shown in FIG. 2. In moving from left to right in FIG. 2, the first detonation mode is a rotating detonation wave. The second detonation mode is an oblique rotating detonation wave (ORDW) produced in a supersonic oblique rotating detonation wave engine (SORDE). The third detonation mode is a standing, normal detonation wave. Finally, the fourth detonation mode is a standing, oblique detonation wave. The first mode is a traditional rotating detonation wave in which the inlet Mach number is subsonic and very low relative to the consumption/detonation wave speed, e.g., the internal inlet speed has a Mach number between 0.01 and 0.5 when the consumption speed has a Mach number between 5 and 6. The second mode includes a faster inlet speed that is still less than the consumption speed (or wave speed), e.g., the inlet flow speed has a Mach number between 1.2 and 6 when the consumption/wave speed has a Mach number between 5-6. The third mode is where the incoming flow velocity is equal to or slightly greater than the consumption speed (Mach 5-6) forming a nearly orthogonal stationary wave. The fourth mode is a stationary oblique detonation where the detonation is confined and restricted by the inlet high-Mach flow (e.g., between Mach 6-17) and the ramp forcing the formation of the oblique detonation wave at an oblique angle to balance the velocity decomposition of the incoming flow.

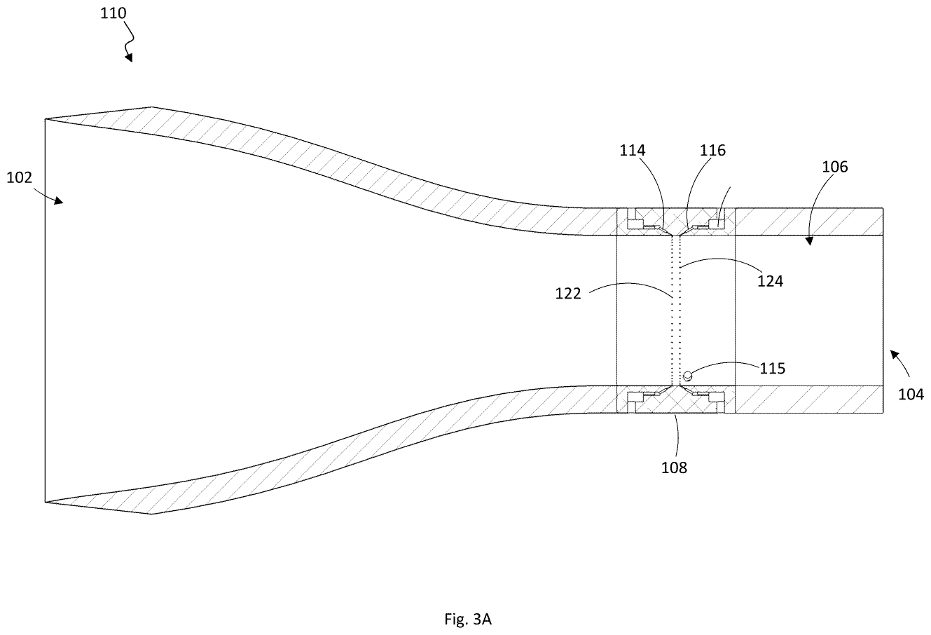

The present invention includes a SORDE and method for producing an ORDW, i.e., a system and method for producing the second mode described above. An embodiment of the SORDE is exemplified in FIG. 3A. As depicted SORDE 100 includes an inlet port 102 and an outlet port 104. The inlet port 102 leads to a propellant injector 108 and an inner detonation chamber 106. The propellants—fuel (e.g., hydrogen) and an oxidizer (e.g., oxygen, ambient air, or an oxygen mixture)—are mixed and detonated using igniter 115 to create and sustain the ORDW in the detonation chamber 106. The explosive energy of the ORDW is directed to exhaust port 104 to produce thrust.

The SORDE 100 further includes the propellant injector 108 configured to direct fuel upstream or into the detonation chamber 106. The SORDE 100 uses one or more air inlet ports 102 configured to intake ambient air and/or an oxidizer injector to direct an oxidizer into or upstream of the detonation chamber 106. In some embodiments, a fuel injector and an oxidizer injector are combined as a single propellant injector 110 as shown in FIGS. 3. However, the oxidizer injector can be separate from the fuel injector.

In some embodiments, as depicted in FIGS. 3, the propellant injector 108 includes an array of fuel injector nozzles 114 arranged about the internal circumference of the propellant injector 108 for injecting a predetermined amount of fuel into the inlet oxidizer and/or injected oxidizer to establish a Stoichiometric air/fuel equivalence ratio of 0.5 to 2.0 or a Stoichiometric oxygen/fuel equivalence ratio of 0.1 to 3.0. In some embodiments, the propellant injector 108 has an annular array of fuel injector nozzles 114 each with outlet aperture 122 having a diameter of about 0.010 inches to about 0.050inches to generate the specified fuel-air or Stoichiometric oxygen/fuel equivalence ratio. In some embodiments, the present invention includes an annular array of fuel injector nozzles 114 each with an outlet aperture diameter of about 0.010 inches to about 0.040inches to generate the specified equivalence ratio. The number, size, and spacing of fuel injector nozzles 114 and apertures 122 relative to the number, size, and spacing of oxidizer inlet ports 102 or nozzles 116 and apertures 124 can be varied so that the mixture of fuel and oxidizer results in a Stoichiometric air/fuel equivalence ratio of 0.5to 2.0 or a Stoichiometric oxygen/fuel equivalence ratio of 0.1 to 3.0.

In some embodiments, the propellant injector 108 is configured to have a pitch of fuel injector nozzles 114 on a time scale of 0.5 to 5 microseconds, which is based on which is based on an M_{CJ}=5-6. For a rotational Mach number of 5.8 to almost 0 (0 case is the standing detonation case), the wave speed is 2,400 m/s to almost zero. Using the time scale of 0.5 to 5 microsecond, the pitch/distance between the fuel injector nozzles 114 is 0.001″ to 0.47″.

In some embodiments, the fuel injector nozzles 114 are configured to direct fuel into the incoming air stream at a predetermined angle and a predetermined flowrate to ensure proper mixing. With respect to the longitudinal axis of the engine, the fuel injector nozzles 114 are directed at relative angles of about 25 degrees to about 90 degrees. In some embodiments, the fuel injector nozzles 114 are directed at angles relative to the longitudinal axis of the engine of about 5-90 degrees.

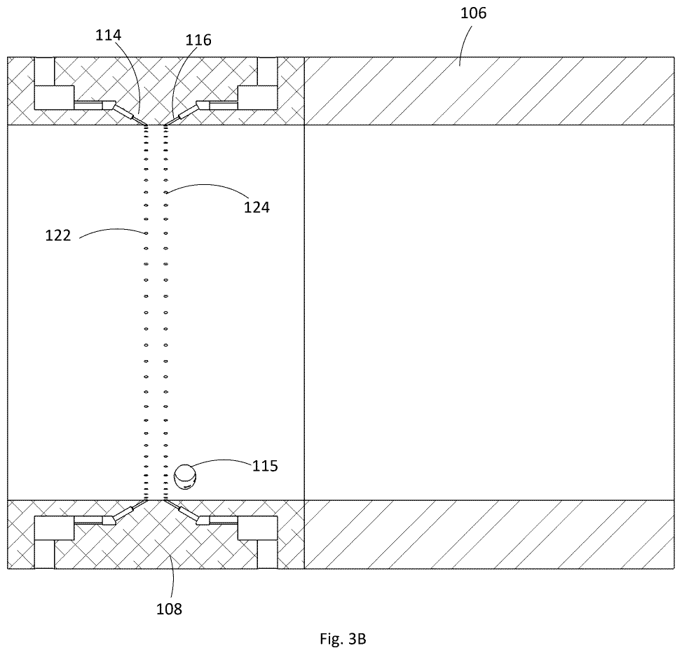

FIGS. 4 depicts an embodiment of a propellant injector 110 that includes an array of fuel and oxidizer injector nozzles 114 and 116 configured to direct propellant into an annulus-shaped detonation chamber. In some embodiments, there are 72 injector pairs (fuel nozzles 114 and oxidizer nozzles 116) arrayed in a circumferential pattern.

The injector nozzle diameters, D are 0.035 inch and 0.045 inch for the fuel and oxidizer injector nozzles 114 and 116, respectively. The injector contour for both the fuel and oxidizer injector nozzles is a simple cylindrical channel of length over diameter ratio, or l/d of 6.468 and 5.695 for the fuel nozzle 114 and oxidizer nozzle 116, respectively.

The full parameters of an embodiment of the propellant injector 110 are listed in Table 1; however, these parameters can be scaled up to a larger diameter SORDE for higher flow rates and these parameters can apply to the propellant injector 108 in FIGS. 3.

| | Hydrogen (Fuel, F) | Oxygen (Oxidizer, O) |
|---|---|---|
| Injector Diameter | 1.2-1.4 | |
| (DO/DF) | | |
| Injector Length by | 6-7 | 5-6 |

| Injector Diameter | |
|---|---|
| (I/D) | |
| Interior Angle | 55-65° |
| Number of Injector Pairs | 2000-2200 per unit inch |
| by Injector Diameter | |
| (N/DF) | |
| Injector Pair Spacing by | 2.5-2.7 |
| Injector Diameter | |
| (a/DF) | |
| Injector Pair Spacing by | 3.3-3.6 |
| Injector Diameter | |
| (b/DF) | |
| Pressure Ratio | 0.8775-1.4917 |
| (PF/PO) | |
| Mass Flow Ratio | 0.1263-0.2147 |
| (mF/mO) | |
| Annulus Width by | 5.5-5.9 |
| Injector Diameter | |
| (Cw/DF) | |
| Annulus Diameter by | 14-16 |
| Annulus Width | |
| (CA/Cw) | |
| Jet Momentum Ratio | 0.51-0.86 |
| (pF/pO) | |

As shown in FIGS. 4, propellant injector 110 of the present invention includes an impinging doublet injection scheme with micronozzle injector channels 114 and 116 that choke the gas propellant flow as it passes through the injector outlet apertures 122 and 124, thereby regulating the flow rate of propellants as it enters the detonation chamber 106. In some embodiments, the interior angle between the impinging doublet nozzle configuration is 60°. In some embodiments, the interior angle between the impinging doublet nozzle configuration is between 55° and 65°.

While the depicted embodiment includes 72 discrete injector pairs arrayed in a circumferential pattern about the injector, the number of pairs may be increased or decreased depending on the size of the SORDE. In some embodiments, the ratio of injector pair spacing in a radial direction by injector diameter is between 2.5 and 2.7. In some embodiments, the ratio of injector pair spacing in a circumferential direction by injector diameter is between 3.3 and 3.6.

Moreover, this injector pattern is meant to sit between an inner and outer body which forms the boundary for the combustor annulus on the detonation chamber 106. Thus, the nozzle locations and the number of nozzle pairings will correspond to the size of the SORDE and in turn the diameter of the detonation chamber 106. In some embodiments, the ratio of the number of injector pairs by injector diameter is between 2000 and 2200 per unit inch.

Each nozzle pair 114, 116 includes a fuel injector nozzle 114 of a generally circular cross section and an oxidizer injector nozzle 116 of similar circular cross section. In some embodiments, the injector diameters, D are 0.035 inch and 0.045 inch for the fuel and oxidizer injector apertures 122, 124, respectively. In some embodiments, the ratio of the oxidizer injector diameter to the fuel injector diameter is between 1.2 and 1.4.

In some embodiments, the injector contour for both the fuel and oxidizer injectors is a simple cylindrical channel 114, 116. However, the shape and cross-sectional shape of the channels may have alternative shapes.

Some embodiments further include a specific length to diameter ratio for the injector channels. For example, the l/d ratio may be between 6.468 and 5.695 for the fuel and oxidizer, respectively. In some embodiments, the l/d ratio for the fuel injector is between 6 and 7, and the l/d ratio for the oxidizer injector is between 5 and 6.

In some embodiments, the sizing of the nozzle diameters maintains an equivalent pressure upstream of the injector 110 at favorable flow conditions of the SORDE for a similar geometry, thereby maintaining similar jet momentums between both propellants and therefore the best mixing conditions for detonability. More specifically, the mass flow rate ratio of fuel to oxidizer can be between 0.1263-0.2147 and the jet momentum ratio of fuel to oxidizer can be between 0.51 and 0.86.

Some embodiments of the SORDE injector are further tailored to the parameters of a SORDE annulus. For example, the ratio of annulus width to injector diameter is between 5.5 and 5.9 and the ratio of annulus diameter to annulus width is 14-16.

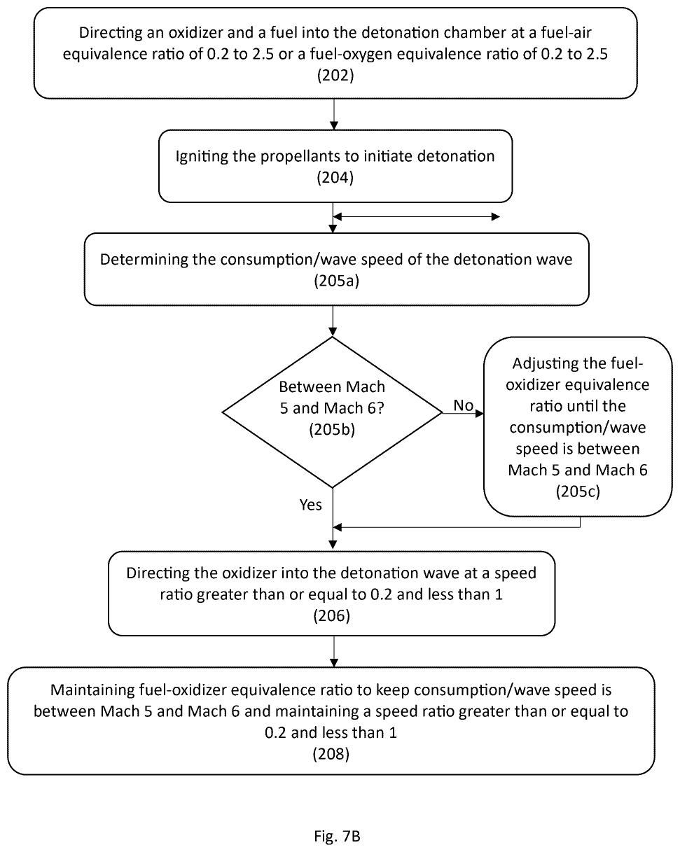

Some embodiments of the present invention, as depicted in FIG. 3, further include a wedge or ramp structure 128 within the engine to aid in mixing and provide a structure from which the oblique wave is formed and supported. In some embodiments the ramp or wedge angle is between 5 degrees and 40 degrees. In some embodiments the ramp or wedge angle is between 10 degrees and 30 degrees. As depicted in FIG. 9, some embodiments of the present invention include a center cylindrical body 130 that establishes an annular shaped detonation channel 106 and helps to create and maintain the detonation.

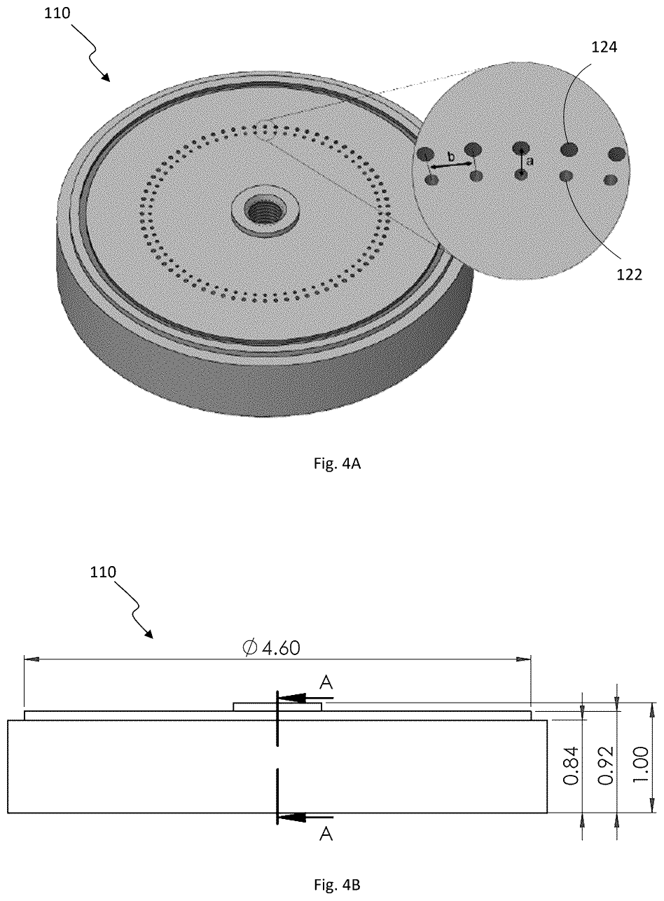

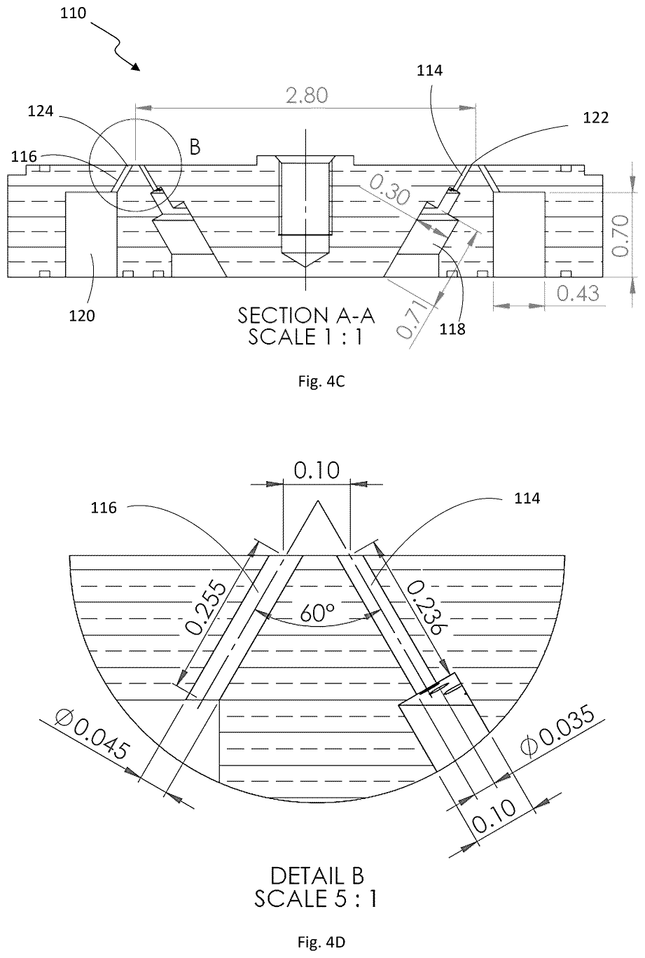

Referring now to FIGS. 5-6, balancing the high-Mach propellant mixture of the inlet flow relative to the consumption speed of the detonation (Chapman-Jouguet (CJ) consumption speed of the detonation wave) or the wave speed of the detonation wave (the wave speed is equivalent to the consumption speed for a rotating detonation wave) is critical for creating and sustaining the ORDW. This critical balance results in a shock that is coupled with the turbulent reactions behind it forming the detonation and energy release mechanism.

Producing and controlling a supersonic ORDW is dependent on the speed of the inlet flow, rotational speed of the detonation wave, and the consumption or wave speed of the detonation wave. The variable Mᵢₙₗₑₜ represents the speed or Mach number of the inlet flow, the variable M_{φ} represents the rotational speed or Mach number of the detonation wave, and the variable M_{CJ} represents the wave speed, i.e., the Mach number of the detonation wave (also referred to as “the consumption speed of the detonation”). These variables can be represented as velocity vectors and are interrelated as shown in FIGS. 5-6 to produce the supersonic ORDW. More specifically, the relationship can be represented by Equation 1 below:

$$ObliqueAngle θ = {sin}^{- 1} ( \frac{{M}_{i nlet}}{{M}_{CJ}} ) \qquad Equation 1$$

The oblique angle θ is between 11.5 and 90 degrees when the Mᵢₙₗₑₜ is between 1.2 and 6 and the M_{CJ} is between 5 and 6. The relationship between velocity vectors can also be represented by Equation 2 below:

$${M}_{ϕ} = {M}_{C J} cos ( θ ) \qquad Equation 2$$

The rotational Mach number, M_{ϕ} is between 5.8 and approaches 0 when the oblique angle θ is between 11.5 and 90 degrees and the M_{CJ} is between 5 and 6.

The system and method for producing a supersonic ORDW and/or a SORDE is also based on combining the ideal flow conditions of the injection fueling, and as previously noted, may include the central cylindrical structure 130 and/or a ramp or wedge 128 to create a front end angle or bluntness to induce the ignition and formation of the rotating detonation. Balancing the ratio of fuel and oxygen with the speed of the inlet flow relative to the consumption speed of the detonation is critical for forming the ORDW. This critical balance results in a shock that is coupled with the reactions behind it forming the detonation and energy release mechanism. Based on the fuel and oxidizer injection which prevents the detonation from propagating upstream relative to the incoming supersonic flow (which is lower than the detonation speed), the oblique detonation forms a rotation at an oblique angle to balance the velocity decomposition of the incoming flow.

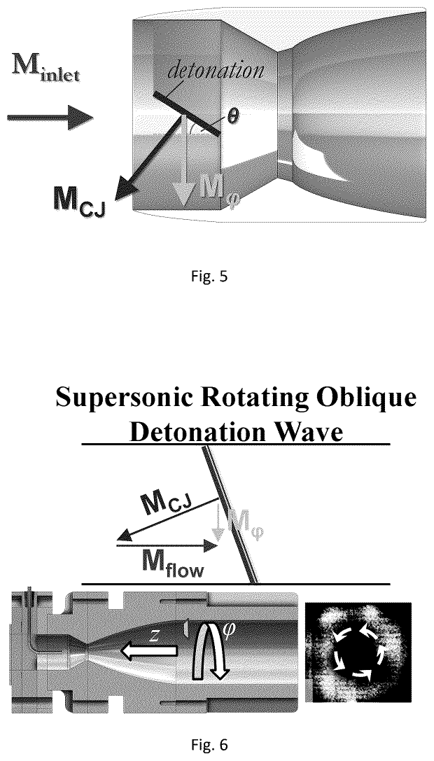

Referring now to FIGS. 7, the present invention includes a method of creating and maintaining an oblique rotating detonation wave in an engine. The method includes directing an oxidizer (e.g., air, oxygen, or a mixture of oxygen and other gases) and a fuel (e.g., hydrogen) into the detonation chamber at a Stoichiometric air/fuel equivalence ratio of 0.5 to 2.0 or a Stoichiometric oxygen/fuel equivalence ratio of 0.1 to 3.0 at step 202. In some embodiments, the fuel is hydrogen and/or the oxidizer is air, oxygen, or a mixture of oxygen and other gases.

The method further includes igniting the propellants (i.e., the mixture of the fuel and oxidizer) to initiate the detonation at step 204. The oxidizer is directed into the detonation at a speed that is less than the consumption/wave speed to create the oblique rotating wave at step 206. In some embodiments, the inlet oxidizer speed is sufficiently adjusted in step 206 to create a ratio of inlet oxidizer speed to wave/consumption speed that is greater than or equal to 0.2 and less than 1. For the sake of brevity, the ratio above will be referred to hereinafter as the “speed ratio.” In some embodiments, the inlet oxidizer speed is between Mach 1.2 to Mach 6 when the consumption/wave speed is between Mach 5 and Mach 6.

The inlet oxidizer can be provided by the ambient environment through an inlet port or can be provided by an oxidizer injector configured to provide the inlet oxidizer between Mach 1.2 to Mach 6 or in a speed ratio that is greater than or equal to 0.2 and less than 1. Thus, some embodiments include specific nozzle designs (e.g., converging or converging-diverging nozzles) for injecting or altering the speed of the inlet oxidizer from an inlet port or an oxidizer nozzle. Regardless of the design, the SORDE of the present invention is configured to deliver the inlet oxidizer to the detonation chamber at a speed ratio that is greater than or equal to 0.2 and less than 1.

Some embodiments as depicted in FIG. 7B, include optional steps 205a-205c. At step 205a, the consumption/wave speed of the detonation is determined. Step 205b includes identifying if the consumption/wave speed is within Mach 5 to Mach 6. If not, then step 205c is performed, which includes adjusting the oxidizer/fuel equivalence ratio until the consumption/wave speed of the detonation wave is between Mach 5 and Mach 6. Step 205c may be accomplished by adjusting the flowrate of the oxidizer, the flowrate of the fuel, or both. Step 205 may further include a step of measuring or identifying the consumption/wave speed of the detonation wave after adjusting the oxidizer/fuel equivalence ratio to achieve the desired consumption or wave speed.

Referring now to FIG. 7C, some embodiments of the method further includes steps 207. Step 207a includes determining if an ORDW is formed in the detonation chamber. If not, the speed ratio is adjusted at step 207b until the ORDW is formed. The speed ratio is adjusted by altering the speed of the incoming oxidizer and/or adjusting the oxidizer/fuel equivalence ratio to alter the consumption/wave speed. Once the speed ratio and oxidizer/fuel equivalence ratio create the ORDW, they are both maintained to sustain the ORDW as desired.

### Experimentation

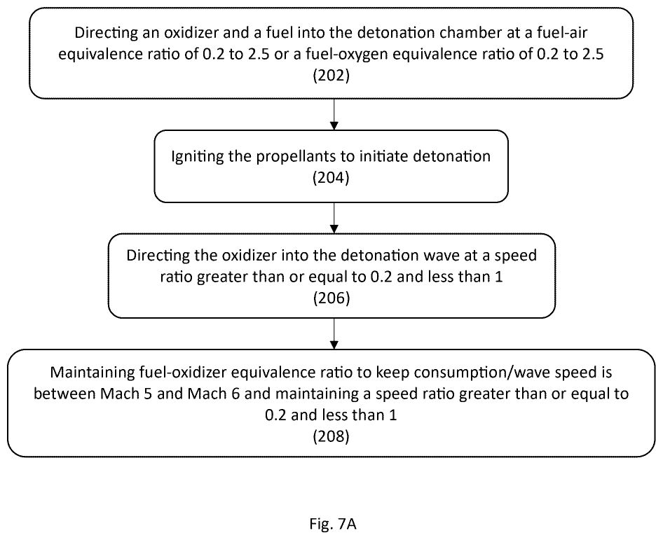

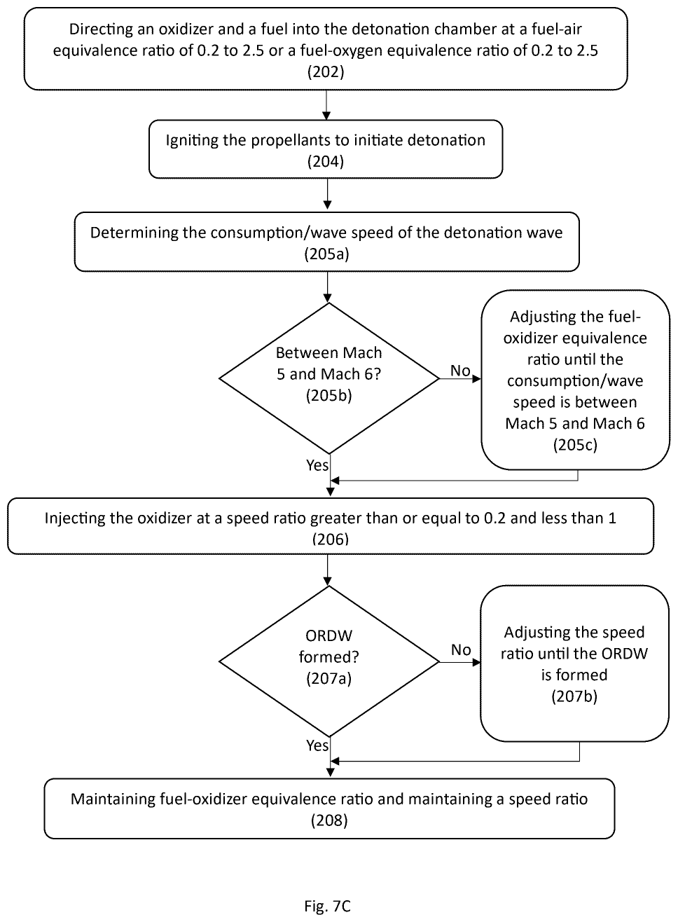

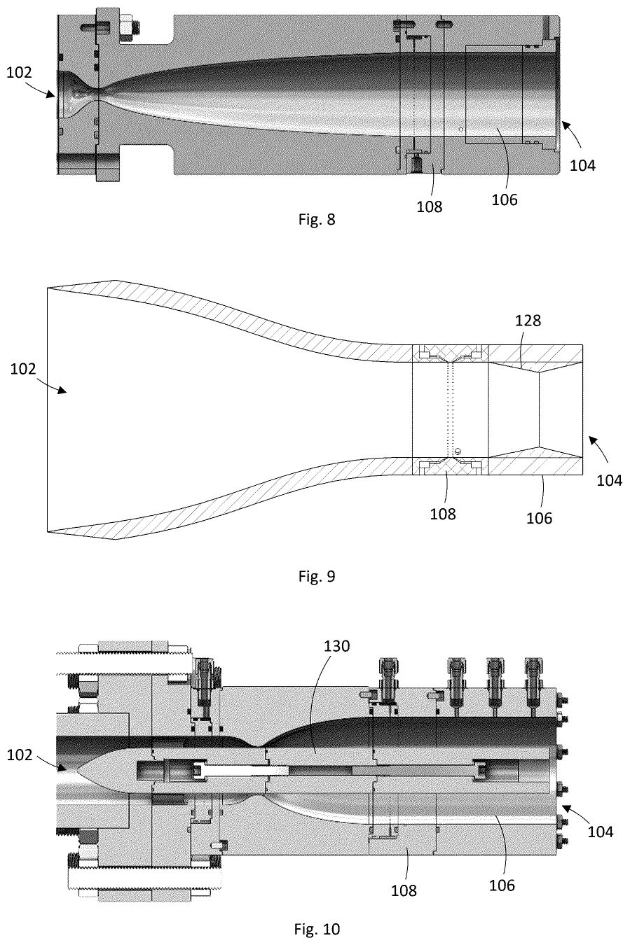

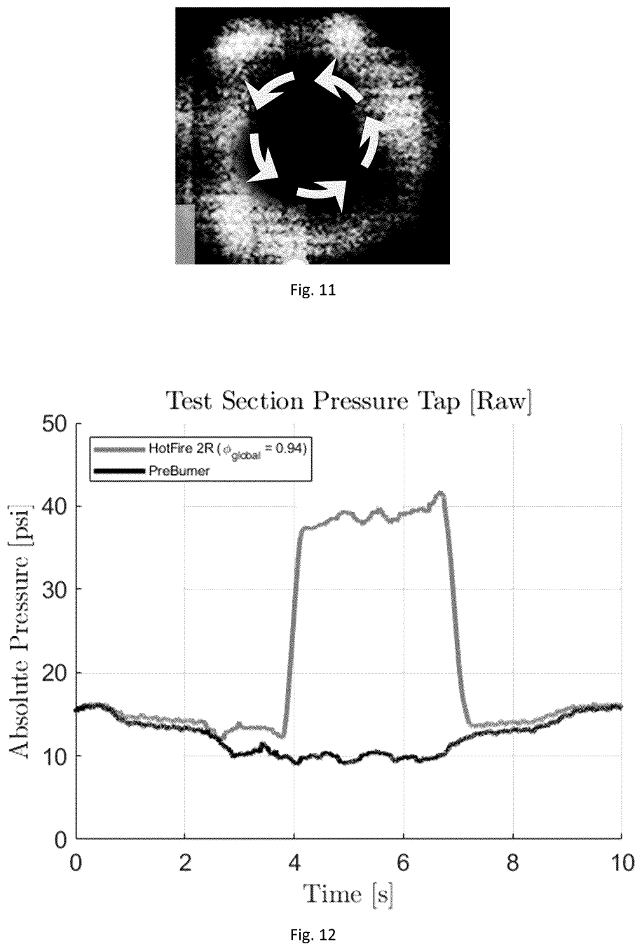

The rotationality of oblique detonation waves in a high Mach flow stream have been demonstrated under preliminary investigation work. Annular Mach 5 configurations have been developed and tested in each of the designs shown in FIGS. 8-10. The results show rotating detonation waves (shown in FIG. 11) traveling at 400-600 m/s from the backend imaging when the freestream velocity is at 1,500 m/s and the CJ detonation velocity is at 1,650 m/s. The high detonation velocity relative to the freestream Mach number results in a rotational component to the oblique detonation wave for fuel consumption. This is clear evidence of ORDW. Furthermore, a pressure rise was measured with the formation of the rotating oblique detonation wave as shown in FIG. 12 confirming the phenomenon.

### REFERENCES

1. Gertz, B. “Hypersonic Arms Race Heats Up as U.S. Builds High-Speed Missiles.” Mar. 8, 2016
2. Macdonald, C. “Russia reveals world's first test of radical pulse-detonation ‘super-rocket’.” 29 Aug. 2016.
3. Lopez, C. T. “Hypersonics Remain Top Priority for DOD.” 2019.
4. Rosato, D. A., Thornton, M., Sosa, J., Bachman, C., Goodwin, G. B., and Ahmed, K. A. “Stabilized detonation for hypersonic propulsion,” Proceedings of the National Academy of Sciences Vol. 118, No. 20, 2021, p. e2102244118.
5. Lovett, J. A., Brogan, T. P., Philippona, D. S., Keil, B. V., and Thompson, T. V. “Development needs for advanced afterburner designs,” 40 th AIAA/ASME/SAE/ASEE Joint Propulsion Conference and Exhibit. 2004.
6. Turns, S. R. An Introduction to Combustion: Concepts and Applications: McGraw-Hill, 1996.
7. Wintenberger, E., and Shepherd, J. “Thermodynamic analysis of combustion processes for propulsion systems,” AIAA paper. Vol. 1033, 2004, p. 18.
8. Peters, N. Turbulent Combustion. U.K.: Cambridge University Press, 2000.
9. “From New York to LA in 30 minutes? UCF discovery could be key to hypersonic travel,” News 6. 2019.
10. “Never-ending detonations could blast hypersonic craft into space.” https://www.livescience.com/detonations-propel-hypersonic-craft-into-space.html, 2021.
11. “Detonation-based engine could propel jets to Mach 17, paving way for interplanetary travel.” https://academictimes.com/detonation-based-engine-could-propel-jets-to-mach-17-paving-way-for-interplanetary-travel/, 2021.
12. “Frozen detonation could enable hypersonic flight.” https://physicsworld.com/a/frozen-detonation-could-enable-hypersonic-flight/, 2021.
13. “World first: Oblique wave detonation engine may unlock Mach 17 aircraft.” https://newatlas.com/aircraft/oblique-wave-detonation-engine-hypersonic-ucf/, 2021.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. An oblique rotating detonation engine, comprising:
a detonation chamber in fluidic communication with a source of an oxidizer and a source of a fuel;
an oxidizer inlet configured to direct the oxidizer to the detonation chamber;
a fuel injector configured to deliver fuel to the detonation chamber;
wherein the fuel injector and oxidizer inlet are configured to deliver the fuel and the oxidizer to the detonation chamber in an equivalence ratio of about 0.1 to about 3.0 to create a detonation wave; and
wherein the oxidizer inlet is configured to direct the oxidizer to the detonation chamber at a speed that is less than, but greater than or equal to 0.2 times a wave speed of the created detonation wave.

2. The engine of claim 1, wherein the fuel injector includes a plurality of fuel injector nozzles each with a diameter of about 0.010 inches to about 0.040 inches.

3. The engine of claim 1, wherein the fuel injector includes a plurality of fuel injector nozzles having a circumferential pitch on a time scale of about 0.5 to about 5 microseconds.

4. The engine of claim 1, wherein the fuel injector includes a plurality of fuel injector nozzles having a circumferential pitch between about 0.001 inches to about 0.47 inches.

5. The engine of claim 1, further including an annular wedge disposed in or upstream of the detonation chamber, wherein the annular wedge has an angle of about 5 degrees to about 40 degrees relative to a longitudinal axis of the detonation chamber.

6. The engine of claim 1, further including a cylindrical center body disposed in or upstream of the detonation chamber, thereby creating an annular detonation channel.

7. The engine of claim 1, wherein operation of the engine produces a supersonic oblique rotating detonation wave with an oblique angle between about 11.5 and about 90 degrees relative to a longitudinal axis of the detonation chamber.

8. The engine of claim 1, wherein operation of the engine produces a supersonic oblique rotating detonation wave with a wave speed between about Mach 5 and about Mach 6.

9. The engine of claim 1, wherein the oxidizer speed is between Mach 1.2 and Mach 6.

10. A method of producing a supersonic oblique rotating detonation wave in an engine, comprising:
injecting an oxidizer and a fuel into a detonation chamber at a oxidizer/fuel equivalence ratio of 0.1 to 3.0;
igniting the fuel to create a detonation wave in the detonation chamber;
directing the oxidizer into the detonation wave at a speed ratio, wherein the speed ratio is a ratio of a speed of the oxidizer relative to a wave speed of the detonation wave and the speed ratio is between 0.2 and 1; and
maintaining the oxidizer/fuel equivalence ratio and the speed ratio to cause the detonation wave to rotate about a longitudinal axis of the detonation chamber.

11. The method of claim 10, further comprising a fuel injector disposed in or upstream of the detonation chamber, wherein the fuel injector includes a plurality of fuel injector ports each having a diameter of about 0.010 inches to about 0.040 inches.

12. The method of claim 10, further including an annular wedge disposed in or upstream of the detonation chamber, wherein the annular wedge has an angle of about 5 degrees to about 40 degrees relative to the longitudinal axis of the detonation chamber.

13. The method of claim 10, further including a cylindrical center body disposed in or upstream of the detonation chamber, thereby creating an annular detonation channel.

14. The method of claim 10, wherein the wave speed is between about Mach 5 and about Mach 6 and the speed of the oxidizer is between Mach 1.2 and Mach 6.

15. The method of claim 10, further including adjusting the oxidizer/fuel equivalence ratio until the wave speed is between about Mach 5 and about Mach 6.

16. The method of claim 10, further including adjusting the speed ratio until the detonation wave creates an oblique angle relative to the longitudinal axis of the detonation chamber and rotates about the longitudinal axis of the detonation chamber.

17. A method of producing a supersonic oblique rotating detonation wave in an engine, comprising:
injecting an oxidizer and a fuel into a detonation chamber
igniting the fuel to create a detonation wave in the detonation chamber;
adjusting the oxidizer/fuel equivalence ratio between 0.1 to 3.0 until the detonation wave has a wave speed between about Mach 5 and about Mach 6;
directing the oxidizer into the detonation wave at a speed ratio that is greater than or equal to 0.2 and less than 1, wherein the speed ratio is a ratio of a speed of the oxidizer relative to the wave speed of the detonation wave; and
maintaining the oxidizer/fuel equivalence ratio and the speed ratio to cause the detonation wave to rotate about a longitudinal axis of the detonation chamber.

18. The method of claim 17, further including an annular wedge disposed in or upstream of the detonation chamber, wherein the annular wedge has an angle of about 5 degrees to about 40 degrees relative to the longitudinal axis of the detonation chamber.

19. The method of claim 17, further including adjusting the oxidizer/fuel equivalence ratio until the wave speed is between about Mach 5 and about Mach 6.

20. The method of claim 17, further including adjusting the speed ratio until the detonation wave creates an oblique angle relative to the longitudinal axis of the detonation chamber and rotates about the longitudinal axis of the detonation chamber.
